(19) United States
(12) Patent Application Publication
(10) Pub. No.: US 2013/0103262 A1
(43) Pub. Date: Apr. 25, 2013

(54) VEHICLE STEERING APPARATUS

(71) Applicant: Chikara Okazaki, Gotenba-shi (JP)

(72) Inventor: Chikara Okazaki, Gotenba-shi (JP)

(73) Assignee: TOYOTA JIDOSHA KABUSHIKI KAISHA, Aichi (JP)

(21) Appl. No.: 13/807,094

(22) PCT Filed: Jun. 17, 2011
(86) PCT No.: PCT/JP11/63958

§ 371 Date: Dec. 27, 2012

(30) Foreign Application Priority Data
Jun. 30, 2010 (JP) 2010-149048

(51) Int. Cl. B62D 6/00

(52) U.S. Cl. CPC B62D 6/00
USPC 701/41

(57) ABSTRACT

A vehicle steering apparatus for setting a target steering reaction force to be applied to a steering wheel on the basis of a steering angle and a vehicle speed and for performing reaction force control to apply the target steering reaction force, is provided with: a steering speed specifying device for specifying a steering speed of the steering wheel; and a target steering reaction force changing device for changing magnitude of the target steering reaction force in accordance with magnitude of an absolute value of the steering speed specified by the steering speed specifying device.

### TECHNICAL FIELD

The present invention relates to a vehicle steering apparatus.

### BACKGROUND ART

As this type of vehicle steering apparatus, there is known an electric power steering (EPS) for setting a target steering reaction force (or “target steering torque”) to be applied to a steering wheel on the basis of a steering angle and a vehicle speed and for performing reaction force control to apply the target steering reaction force to the steering wheel (e.g. refer to Patent document 1). By performing such reaction force control, the steering feeling of a driver can be improved. Moreover, as prior art documents related to the present invention, there are Patent documents 2 and 3.

Prior Art Document

Patent Document

Patent document 1: U.S. Pat. No. 5, 198,981, Specification

Patent document 2: Japanese Patent Application Laid Open No. Hei 06-056046

Patent document 3: Japanese Patent Application Laid Open No. 2006-137215

### Disclosure of Invention

### Subject to be Solved by the Invention

In the technology disclosed in Patent document 1 described above, however, the magnitude of an absolute value of a steering speed at which the driver turns the steering wheel is not considered, and it is likely hard to improve the steering feeling of the driver in some magnitude of the absolute value of the steering speed, which is technically problematic.

In view of the aforementioned problem, it is therefore an object of the present invention to provide a vehicle steering apparatus capable of improving the steering feeling of the driver.

### Means for Solving the Subject

First vehicle steering apparatus of the present invention, in order to solve the above-mentioned object, which is sets a target steering reaction force to be applied to a steering wheel on the basis of a steering angle and a vehicle speed and performs reaction force control to apply the target steering reaction force, is provided with a steering speed specifying device for specifying a steering speed of the steering wheel, and a target steering reaction force changing device for changing magnitude of the target steering reaction force in accordance with magnitude of an absolute value of the steering speed specified by said steering speed specifying device.

According to the first vehicle steering apparatus of the present invention, the target steering reaction force (i.e. a target value of a steering reaction force to be applied to the steering wheel) is set on the basis of the steering angle and the vehicle speed, and the target steering reaction force is applied to the steering wheel by the reaction force control.

In the present invention, in particular, the target steering reaction force changing device changes the magnitude of the target steering reaction force in accordance with the magnitude of the absolute value of the steering speed specified by the steering speed specifying device. This makes it possible to improve the steering feeling of the driver, for example, in comparison with a case where the magnitude of the target steering reaction force is constant, regardless of the magnitude of the absolute value of the steering speed.

In one aspect of the first vehicle steering apparatus of the present invention, said target steering reaction force changing device changes the magnitude of the target steering reaction force such that the magnitude of the target steering reaction force is less than that of the target steering reaction force currently set, if a state in which the magnitude of the absolute value of the steering speed specified by said steering speed specifying device is less than or equal to a threshold value continues for a predetermined period.

According to this aspect, it is possible to more certainly improve the steering feeling of the driver if the state in which the magnitude of the absolute value of the steering speed is less than or equal to the threshold value continues for the predetermined period.

Second vehicle steering apparatus of the present invention, in order to solve the above-mentioned object, which is sets a target steering reaction force to be applied to a steering wheel on the basis of a steering angle and a vehicle speed and performs reaction force control to apply the target steering reaction force, is provided with a target steering reaction force setting device for setting the target steering reaction force such that magnitudes of the target steering reaction force are different from each other between in a case where the steering wheel is in a steering-hold state and in a case where the steering wheel is not in the steering-hold state.

According to the second vehicle steering apparatus of the present invention, the target steering reaction force is set on the basis of the steering angle and the vehicle speed, and the target steering reaction force is applied to the steering wheel by the reaction force control.

In the present invention, in particular, the target steering reaction force setting device sets the target steering reaction force such that the magnitudes of the target steering reaction force are different from each other between in the case where the steering wheel is in the steering-hold state and in the case where the steering wheel is not in the steering-hold state. In other words, for example, the target steering reaction force setting device changes the magnitude of target steering torque between a first magnitude suitable for improving the steering feeling in the case where the steering wheel is in the steering-hold state, and a second magnitude suitable for improving the steering feeling in the case where the steering wheel is not in the steering-hold state.

Thus, it is possible to improve the steering feeling of the driver, for example, in comparison with a case where the magnitude of the target steering reaction force is the same between in the case where the steering wheel is in the steering-hold state and in the case where the steering wheel is not in the steering-hold state.

In one aspect of the second vehicle steering apparatus of the present invention, said target steering reaction force setting device sets the target steering reaction force such that the magnitude of the target steering reaction force in the case where the steering wheel is in the steering-hold state is less than that in the case where the steering wheel is not in the steering-hold state.

According to this aspect, it is possible to more certainly improve the steering feeling of the driver in the case where the steering wheel is in the steering-hold state.

The operation and other advantages of the present invention will become more apparent from Mode for Carrying Out the Invention explained below.

### BRIEF DESCRIPTION OF DRAWINGS

FIG. 1 is a block diagram conceptually illustrating an entire configuration of a vehicle provided with a vehicle steering apparatus in an embodiment of the present invention.

FIG. 2 is a block diagram conceptually illustrating a configuration of a controller in the embodiment of the present invention.

FIG. 3 is a flowchart illustrating a flow of setting a target steering reaction force in reaction force control in the embodiment of the present invention.

FIG. 4 is a map for defining the target steering reaction force for a normal state.

FIG. 5 is a map for defining the target steering reaction force for a steering hold state.

### MODE FOR CARRYING OUT THE INVENTION

Hereinafter, an embodiment of the present invention will be explained with reference to the drawings.

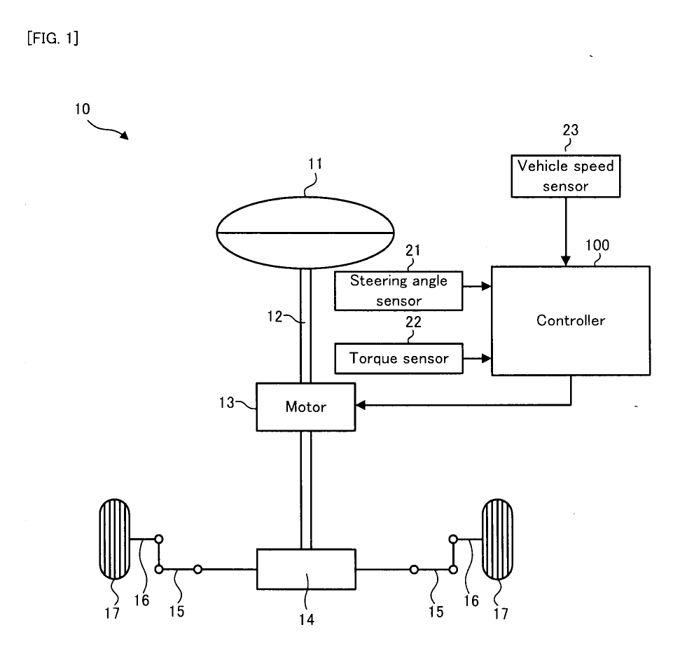

A vehicle steering apparatus in the embodiment will be explained with reference to FIG. 1 to FIG. 5.

Firstly, an entire configuration of a vehicle provided with the vehicle steering apparatus in the embodiment will be explained with reference to FIG. 1.

FIG. 1 is a block diagram conceptually illustrating the entire configuration of the vehicle provided with the vehicle steering apparatus in the embodiment.

In FIG. 1, a vehicle 10 provided with the vehicle steering apparatus in the embodiment is provided with a steering wheel 11, a steering shaft 12, a motor 13, a rack and pinion unit 14, tie rods 15, knuckle arms 16, wheels 17, a steering angle sensor 21, a torque sensor 22, a vehicle speed sensor 23, and a controller 100.

The steering wheel 11 (hereinafter simply referred to as a “steering 11”, as occasion demands) is one example of the “steering wheel” of the present invention, and is operated by a driver to turn the vehicle 10 or to perform similar actions. The steering 11 is connected to the rack and pinion unit 14 via the steering shaft 12. The steering shaft 12 has the steering angle sensor 21, the torque sensor 22, and the motor 13 disposed thereon.

The steering angle sensor 21 detects a steering angle corresponding to the operation of the steering 11 by the driver. The steering angle sensor 21 provides the controller 100 with a detection signal corresponding to the detected steering angle.

The torque sensor 22 detects torque acting on the steering shaft 12. The torque sensor 22 provides the controller 100 with a detection signal corresponding to the detected torque.

The vehicle speed sensor 23 detects a vehicle speed of the vehicle 10, and provides the controller 100 with a detection signal corresponding to the detected vehicle speed.

The motor 13 is provided with a reduction gear, an electric motor and the like, and applies torque to the steering shaft 12 under control by the controller 100. Hereinafter, the torque applied by the motor 13 to the steering shaft 12 will be referred to as “assist torque”, as occasion demands.

The rack and pinion unit 14 is provided with a rack and a pinion, and operates by rotation transferred from the steering shaft 12. To the rack and pinion unit 14, the tie rods 15 and the knuckle arms 16 are connected. To the knuckle arms 16, the wheels 17 are connected. In this case, the tie rods 15 and the knuckle arms 16 are operated by the rack and pinion unit 14, by which the wheels 17 connected to the knuckle arms 16 are steered.

The controller 100 is an electronic control unit provided with a central processing unit (CPU), a read only memory (ROM), a random access memory (RAM) and the like. The controller 100 performs reaction force control for controlling the motor 13 so as to apply a target steering reaction force to the motor 13, on the basis of the respective detection signals supplied from the steering angle sensor 21, the torque sensor 22, and the vehicle speed sensor 23. In other words, in the reaction force control, the assist torque applied by the motor 13 to the steering shaft 12 is controlled by the controller 100 so as to apply the target steering reaction force to the steering 11.

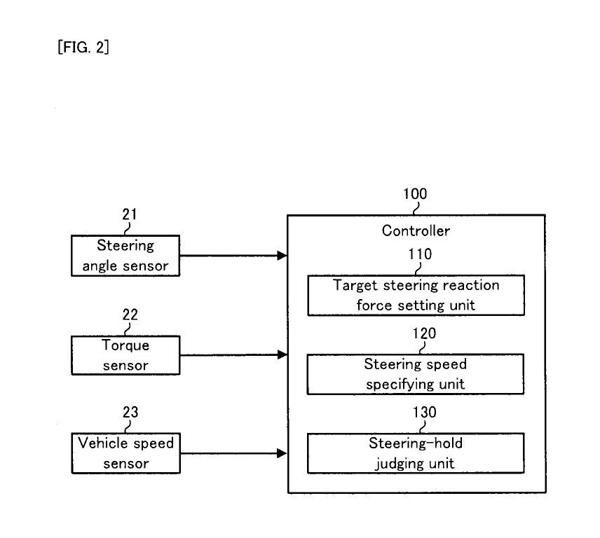

FIG. 2 is a block diagram conceptually illustrating a configuration of the controller 100.

The controller 100 is provided with a target steering reaction force setting unit 110, a steering speed specifying unit 120, and a steering-hold judging unit 130. Incidentally, the target steering reaction force setting unit 110 functions as one example of the “target steering reaction force setting device” of the second vehicle steering apparatus of the present invention and as one example of the “target steering reaction force changing device” of the first vehicle steering apparatus of the present invention.

The steering speed specifying unit 120 specifies a steering speed at which the steering 11 is turned, on the basis of the detection signal supplied from the steering angle sensor 21. Specifically, the steering speed specifying unit 120 specifies the steering speed of the steering 11 by calculating time variations of the steering angle detected by the steering sensor 21.

The steering-hold judging unit 130 judges whether or not the steering 11 is in a steering-hold state. Specifically, the steering-hold judging unit 13—judges, on the basis of the steering angle detected by the steering angle sensor 21 and the steering speed specified by the steering speed specifying device 120, that the steering 11 is in the steering-hold state if a state in which the steering angle is greater than or equal to a steering angle threshold value and the magnitude of an absolute value of the steering speed is less than or equal to a steering speed threshold value continues for a first predetermined time or more, and judges that the steering 11 is in a normal state, which is not the steering-hold state, if the other states (i.e. a state in which the steering angle is less than the steering angle threshold value, or a state in which the magnitude of the absolute value of the steering speed is greater than the steering speed threshold value) continues for a second predetermined time or more.

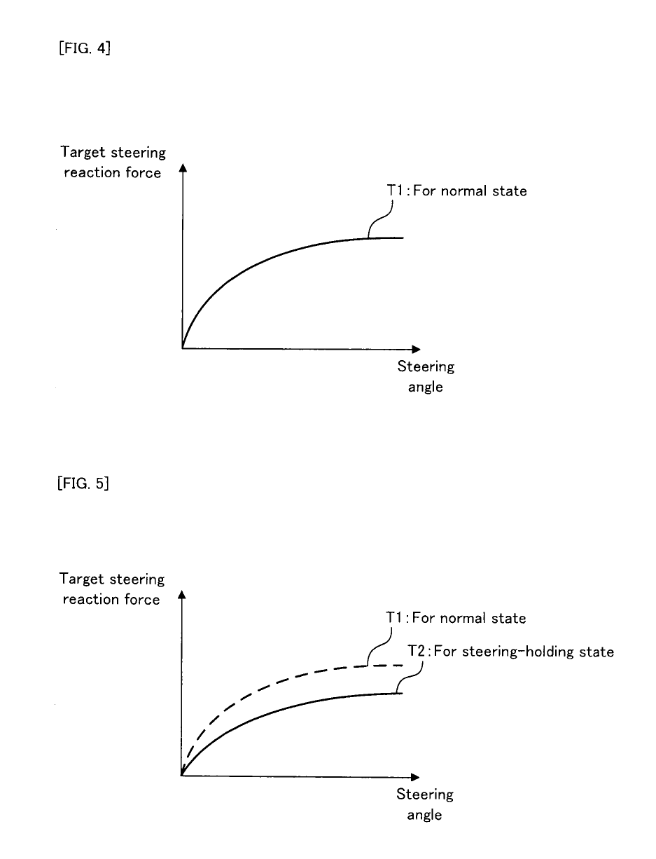

The target steering reaction force setting unit 110 sets the target steering reaction force to be applied to the steering 11, on the basis of the respective detection signals supplied from the steering angle sensor 21 and the vehicle sensor 23. More specifically, the target steering reaction force setting unit 110 sets the target steering reaction force to be applied to the steering 11, on the basis of a target steering reaction force map described later with reference to FIG. 4 and FIG. 5. The target steering reaction force map is stored in the ROM or the RAM of the controller 100.

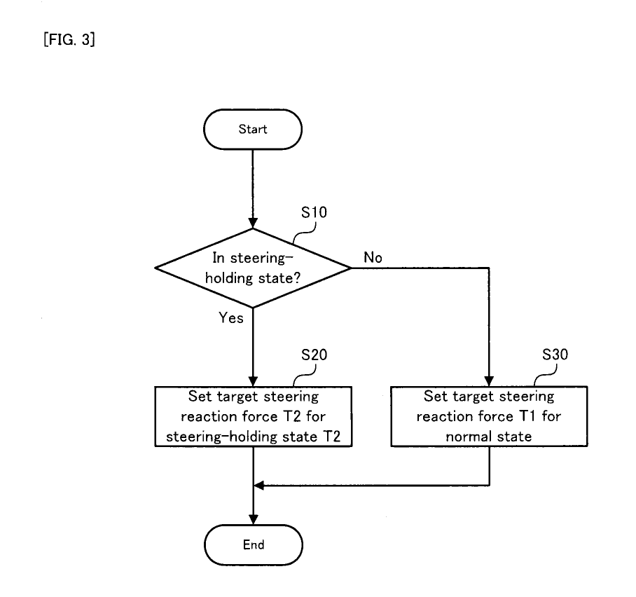

Next, the reaction force control by the vehicle steering apparatus in the embodiment will be explained with reference to FIG. 3. Hereinafter, an explanation will be given mainly to the setting of the target steering reaction force when the vehicle steering apparatus in the embodiment performs the reaction force control.

FIG. 3 is a flowchart illustrating a flow of setting the target steering reaction force in the reaction force control.

In FIG. 3, in the reaction force control, firstly, it is judged by the steering-hold judging unit 130 (refer to FIG. 2) whether or not the steering 11 is in the steering-hold state (step S10).

If it is judged that the steering 11 is not in the steering-hold state (i.e. the steering 11 is in the normal state) (the step S10: No), the target steering reaction force setting unit 110 sets a target steering reaction force T1 for the normal state, as the target steering reaction force to be applied to the steering 11, on the basis of a target steering reaction force map for the normal state as illustrated in a graph in FIG. 4 (step S30). The target steering reaction force map for the normal state is a map for defining the target steering reaction force in the case where the steering 11 is in the normal state, in accordance with the steering angle and the vehicle speed. Incidentally, FIG. 4 illustrates only a relation between the steering angle and the target steering reaction force in the target steering reaction force map for the normal state and omits the illustration of a relation between the vehicle speed and the target steering reaction force.

On the other hand, if it is judged that the steering 11 is in the steering-hold state (the step S10: Yes), the target steering reaction force setting unit 110 sets a target steering reaction force T2 for the steering-hold state, as the target steering reaction force to be applied to the steering 11, on the basis of a target steering reaction force map for the steering-hold state as illustrated by a solid line in a graph in FIG. 5 (step S20). The target steering reaction force map for the steering-hold state is a map for defining the target steering reaction force in the case where the steering 11 is in the steering-hold state, in accordance with the steering angle and the vehicle speed. Incidentally, FIG. 5 illustrates only the relation between the steering angle and the target steering reaction force in the target steering reaction force map for the steering-hold state and omits the illustration of the relation between the vehicle speed and the target steering reaction force.

In the embodiment, in particular, as illustrated in FIG. 5, the magnitude of the target steering reaction force T2 for the steering-hold state is less than that of the target steering reaction force T1 for the normal state.

That is, the target steering reaction force setting unit 110 sets the target steering reaction force such that the magnitude of the target steering reaction force in the case where the steering 11 is in the steering-hold state (the step S10: Yes) is less than that in the case where the steering 11 is in the normal state (the step S10: No). In other words, the target steering reaction force setting unit 110 changes the target steering reaction force to be applied to the steering 11 between the target steering reaction force T1 for the normal state and the target steering reaction force T2 for the steering-hold state which is less in magnitude than the target steering reaction force T1 for the normal state. Thus, it is possible to reduce the steering reaction force which is not necessary for the driver who keeps the steering 11 in the steering-hold state, thereby certainly improving the steering feeling of the driver in the steering-hold state.

Incidentally, the embodiment exemplifies the case where the magnitude of the target steering reaction force T2 for the steering-hold state is less than that of the target steering reaction force T1 for the normal state; however, the magnitude of the target steering reaction force T2 for the steering-hold state may be greater than that of the target steering reaction force T1 for the normal state. Even in this case, it is possible to apply to the steering 11 the steering reaction force having different magnitudes between in the case where the steering 11 is in the normal state and in the case where the steering 11 is in the steering-hold state, thereby improving the steering feeling of the driver.

Incidentally, the embodiment exemplifies that it is judged whether or not the steering 11 is in the steering-hold state and that the target steering reaction force is changed in accordance with the judgment result; however, it may be configured to change the magnitude of the target steering reaction force in accordance with the magnitude of the absolute value of the steering speed specified by the steering speed specifying unit 120. Such a configuration makes it possible to improve the steering feeling of the driver, for example, in comparison with a case where the magnitude of the target steering reaction force is constant, regardless of the magnitude of the absolute value of the steering speed.

The present invention is not limited to the aforementioned embodiment, but various changes may be made, if desired, without departing from the essence or spirit of the invention which can be read from the claims and the entire specification. A vehicle steering apparatus, which involves such changes, is also intended to be within the technical scope of the present invention.

### DESCRIPTION OF REFERENCE CODES

11 steering wheel
12 steering shaft
13 motor
17 wheel
21 steering angle sensor
22 torque sensor
23 vehicle speed sensor
100 controller
110 target reaction force setting unit
120 steering speed specifying unit
130 steering-hold judging unit

1. A vehicle steering apparatus for setting a target steering reaction force to be applied to a steering wheel on the basis of a steering angle and a vehicle speed and for performing reaction force control to apply the target steering reaction force, said vehicle steering apparatus comprising:
a steering speed specifying device for specifying a steering speed of the steering wheel; and
a target steering reaction force changing device for changing magnitude of the target steering reaction force in accordance with magnitude of an absolute value of the steering speed specified by said steering speed specifying device,
said target steering reaction force changing device changing the magnitude of the target steering reaction force such that the magnitude of the target steering reaction force is less than that of the target steering reaction force currently set, in the case of a steering-hold state in which the magnitude of the absolute value of the steering speed specified by said steering speed specifying device is less than or equal to a threshold value continues for a predetermined period.

2. (canceled)

3. The vehicle steering apparatus according to claim 1, wherein said target steering reaction force changing device sets the target steering reaction force such that magnitudes of the target steering reaction force are different from each other between in the case of the steering-hold state and in the case of a state which is not the steering-hold state.

4. The vehicle steering apparatus according to claim 3, wherein said target steering reaction force changing device sets the target steering reaction force such that the magnitude of the target steering reaction force in the case of the steering-hold state is less than that in the case of the state which is no the steering-hold state.

5. A vehicle steering apparatus which sets a target steering reaction force to be applied to a steering wheel on the basis of a steering angle and a vehicle speed, and which performs reaction force control to apply the target steering reaction force, said vehicle steering apparatus comprising:
a steering speed specifying device which specifies a steering speed of the steering wheel; and
a target steering reaction force changing device which changes magnitude of the target steering reaction force in accordance with magnitude of an absolute value of the steering speed specified by said steering speed specifying device,
said target steering reaction force changing device changing the magnitude of the target steering reaction force such that the magnitude of the target steering reaction force is less than that of the target steering reaction force currently set, in the case of a steering-hold state in which the magnitude of the absolute value of the steering speed specified by said steering speed specifying device is less than or equal to a threshold value continues for a predetermined period.
